(19) United States
(12) Patent Application Publication
(10) Pub. No.: US 2025/0303290 A1
(43) Pub. Date: Oct. 2, 2025

(54) INFORMATION PROCESSING APPARATUS AND IMAGE GENERATION METHOD

(71) Applicant: Sony Interactive Entertainment Inc., Tokyo (JP)

(72) Inventors: Nodoka TOKUNAGA, Tokyo (JP); Kiyobumi MATSUNAGA, Tokyo (JP); Masahiro FUJIHARA, Tokyo (JP)

(73) Assignee: Sony Interactive Entertainment Inc., Tokyo (JP)

(21) Appl. No.: 18/881,770

(22) PCT Filed: Jul. 20, 2023
(86) PCT No.: PCT/JP2023/026528

§ 371 Date: Jan. 7, 2025

(30) Foreign Application Priority Data
Aug. 25, 2022 (JP) 2022-134458

(51) Int. Cl. A63F 13/525; A63F 13/21; A63F 13/25; A63F 13/86; G02B 27/00; G02B 27/01; G06F 3/04842; G06T 11/60; G09G 5/377

(52) U.S. Cl. CPC A63F 13/525; A63F 13/21; A63F 13/25; A63F 13/86; G02B 27/0093; G02B 27/017; G06F 3/04842; G06T 11/60; G09G 5/377

(57) ABSTRACT

An estimation processing section derives attitude information indicative of the attitude of an HMD worn by a user on the head. A game image generation section generates a content image in a three-dimensional virtual reality space for display on the HMD based on the attitude information regarding the HMD. A system image generation section generates a system image allowing the user wearing the HMD on the head to make settings regarding a camera image for broadcast along with the content image.

### TECHNICAL FIELD

The present disclosure relates to a technology for generating images to be displayed on a head-mounted display.

### BACKGROUND ART

It is general practice that a user wears a head-mounted display (also referred to as the HMD hereunder) on the head and plays games by operating a game controller while viewing a game image displayed on an HMD. With the image in a three-dimensional virtual reality space displayed on the HMD subjected to a tracking process, imagery in the virtual reality space may be synchronized with the movement of the user's head. This can not only increase the user's sense of immersion in a visual world but also enhance a level of entertainment of the games.

### CITATION LIST

### Patent Literature

[PTL 1]

### SUMMARY

### Technical Problem

In recent years, it has become common to stream playing game videos on SNS (social networking service). It has thus been desired to provide users with schemes of simply streaming game videos. In a case where the user wearing the HMD is to stream a camera image capturing the user along with the playing game video, the user may feel bothered if it is necessary to remove the HMD from the head in order to make settings regarding the camera image.

In view of the above, it is an object of the present disclosure to provide a scheme of allowing the user wearing the HMD to make settings regarding the streaming of the camera image.

### Solution to Problem

In solving the above problem and according to an embodiment of the present disclosure, there is provided an information processing apparatus including an estimation processing section that derives attitude information indicative of an attitude of a head-mounted display worn by a user on the head, a first image generation section that generates a content image in a three-dimensional virtual reality space for display on the head-mounted display on the basis of the attitude information regarding the head-mounted display, and a second image generation section that generates a system image allowing the user wearing the head-mounted display on the head to make settings regarding a camera image for broadcast along with the content image.

According to another embodiment of the present disclosure, there is provided an image generation method including deriving attitude information indicative of an attitude of a head-mounted display worn by a user on the head, generating a content image in a three-dimensional virtual reality space for display on the head-mounted display on the basis of the attitude information regarding the head-mounted display, and generating a system image allowing the user wearing the head-mounted display on the head to make settings regarding a camera image for broadcast along with the content image.

Incidentally, if the above-outlined suitable combinations, constituent elements, or expressions of the present disclosure are converted between different forms such as a method, a program, a temporary or non-temporary recording medium that records the program, and a system, they also constitute effective embodiments of this disclosure.

### BRIEF DESCRIPTION OF DRAWINGS

FIG. 1 is a diagram depicting an exemplary configuration of an information processing system having an embodiment of the present disclosure.

FIG. 2 is a diagram depicting an exemplary external shape of an HMD.

FIG. 3 is a diagram indicating functional blocks of the HMD.

FIG. 4 is a diagram indicating functional blocks of an information processing apparatus.

FIG. 5 is a diagram depicting an exemplary game image displayed on a display panel.

FIG. 6 is a diagram depicting an exemplary first system image displayed on the display panel.

FIG. 7 is a diagram depicting another exemplary first system image displayed on the display panel.

FIG. 8 is a diagram depicting an exemplary second system image displayed on the display panel.

FIG. 9 is a diagram depicting an exemplary third system image displayed on the display panel.

FIG. 10 is a diagram depicting an exemplary fourth system image displayed on the display panel.

FIG. 11 is a diagram depicting an exemplary second system image in a case where a broadcast function is activated.

FIG. 12 is a diagram depicting an exemplary fifth system image displayed on the display panel.

FIG. 13 is a diagram depicting a state in which the fifth system image is displayed in a top left corner of the screen.

FIG. 14 is a diagram depicting an image displayed on an output apparatus.

FIG. 15 is a diagram depicting an image displayed on the display panel.

### DESCRIPTION OF EMBODIMENT

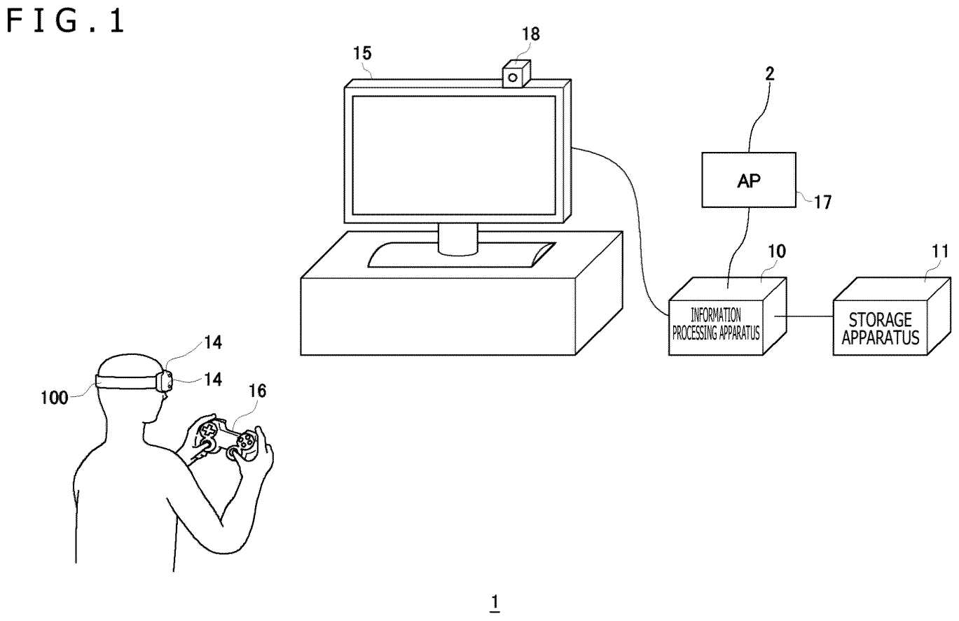

FIG. 1 is a diagram depicting an exemplary configuration of an information processing system 1 having an embodiment of the present disclosure. The information processing system 1 includes an information processing apparatus 10, a recording apparatus 11, a head-mounted display (HMD) 100 worn by a user on the head, an input device 16 operated by the user with fingertips, an output apparatus 15 outputting images and sounds, and an imaging apparatus 18 capturing an image of the user. The output apparatus 15, which is a flat-screen display, may be a floor-standing television receiver, a projector that projects images on a screen or on a wall, or the display of a tablet terminal or mobile terminal. The imaging apparatus 18 may be a stereo camera placed near the output apparatus 15 to capture the image of the user wearing the HMD 100 on the head. The imaging apparatus 18 may be positioned anywhere as long as it can capture the user's image.

The information processing apparatus 10 connects to an external network 2 such as the Internet via an access point (AP) 17. The AP 17 has the functions of a wireless access point and a router. The information processing apparatus 10 may be connected to the AP 17 by cable or through a known wireless communication protocol. The information processing apparatus 10 connects via the network 2 to a server apparatus providing SNS and can stream content (game videos) to the server apparatus. The information processing apparatus 10 may allow the camera image captured by the imaging apparatus 18 to be included in the content stream.

The recording apparatus 11 records system software and applications such as game software. The information processing apparatus 10 may download game software to the recording apparatus 11 from a game server (not depicted) via the network 2. The information processing apparatus 10 executes game programs and supplies image and sound data of the games to the HMD 100 and to the output apparatus 15. The information processing apparatus 10 and the HMD 100 may be interconnected through a known wireless communication protocol or by cable.

The HMD 100, worn by the user on the head, is a display apparatus that displays images on a display panel positioned in front of the user's eyes. The HMD 100 has a left-eye image and a right-eye image displayed on a left-eye display panel and a right-eye display panel, respectively, the two images being displayed independently of each other. These images are parallax images seen from right and left viewpoints and constitute a stereoscopic vision. Since the user views the display panels through optical lenses, the information processing apparatus 10 provides the HMD 100 with left-eye and right-eye image data corrected for optical distortion caused by the lenses.

Although the user wearing the HMD 100 has no need for the output apparatus 15, other users can view display images that may be output on the output apparatus 15. The information processing apparatus 10 may allow the output apparatus 15 to display either the same image as that viewed by the user wearing the HMD 100 or another image.

For the embodiment, the term “mirroring mode” refers to a mode in which the same display image as that for the HMD 100 is displayed on the output apparatus 15, and the term “separate mode” refers to a mode in which an image different from the display image on the HMD 100 is displayed on the output apparatus 15. The game software of the embodiment has a function of separately generating the image for the HMD 100 and the image for the output apparatus 15. Whether the image for the output apparatus 15 is generated in mirroring mode or in separate mode depends on the game software at the discretion of the game developers. For example, in a piece of game software, the image for the output apparatus 15 may be generated in mirroring mode in some scenes and in separate mode in other scenes. In the embodiment, the image for the output apparatus 15 is assumed to be generated in mirroring mode. In a modification, the image for the output apparatus 15 may be generated in separate mode.

The information processing apparatus 10 and the input device 16 may be interconnected either through a known wireless communication protocol or by cable. The input device 16 has multiple operating members including operation buttons, arrow keys, and analog sticks. The user operates the operating members with fingertips while gripping the input device 16 by hand. When the information processing apparatus 10 executes game programs, the input device 16 is used as a game controller.

Multiple imaging apparatuses 14 are mounted on the HMD 100. These imaging apparatuses 14 are attached to different positions on the front surface of the HMD 100. The imaging apparatuses 14 may include visible light sensors such as CCD (Charge Coupled Device) sensors or CMOS (Complementary Metal Oxide Semiconductor) sensors used by common digital video cameras. The multiple imaging apparatuses 14 capture images in front of the user in a predetermined cycle (e.g., 60 frames/second) with a synchronized timing, and transmit the captured images to the information processing apparatus 10.

The information processing apparatus 10 has a function of estimating at least either the position or the attitude of the HMD 100 based om the images captured around the HMD 100. The information processing apparatus 10 may estimate the position and/or the attitude of the HMD 100 by SLAM (Simultaneous Localization And Mapping) estimating the self-position and creating an environmental map simultaneously. In the ensuing paragraphs, it is assumed, for explanatory purposes, that the information processing apparatus 10 has the function of estimating both the position and the attitude of the HMD 100.

The information processing apparatus 10 estimates an amount of movement of the HMD 100 between time (t-1) and time (t), which are continuous, using the images captured by the imaging apparatuses 14 at time (t-1) and time (t). The information processing apparatus 10 estimates the position and attitude of the HMD 100 at time (t) using the position and attitude of the HMD 100 at time (t-1) and the amount of movement of the HMD 100 between time (t-1) and time (t). The information processing apparatus 10 derives position information indicative of the position of the HMD 100 as position coordinates in a coordinate system defined in real space. Also, the information processing apparatus 10 derives attitude information indicative of the attitude of the HMD 100 as directions in the coordinate system defined in real space. The information processing apparatus 10 may derive the position information and attitude information with high accuracy by further using sensor data acquired between time (t-1) and time (t) by an attitude sensor mounted on the HMD 100.

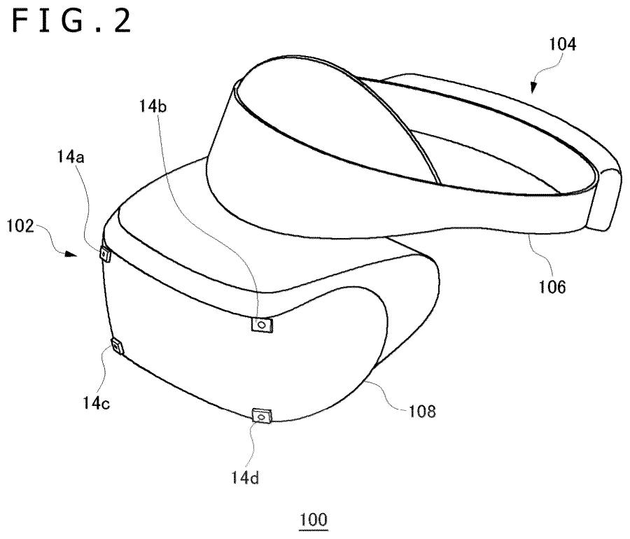

FIG. 2 depicts an exemplary external shape of the HMD 100. The HMD 100 is configured by an output mechanism section 102 and a wearing mechanism section 104. The wearing mechanism section 104 includes a wearing band 106 worn by the user around the head to secure the HMD 100 on the head. The wearing band 106 includes a material or a structure adjustable to allow for the user's head circumference.

The output mechanism section 102 includes a housing 108 shaped to cover the right and left eyes of the user wearing the HMD 100. Inside the housing 108 is a display panel directly facing the eyes when the HMD 100 is worn. The display panel may be a liquid crystal display panel or an organic EL display panel. Also inside the housing 108 are a pair of right and left optical lenses positioned between the display panel and the user's eyes for widening the user's viewing angle. Furthermore, the HMD 100 may be equipped with speakers or earphones positionally corresponding to the user's ears or may be configured to be connectable with external headphones.

Multiple imaging apparatuses 14a, 14b, 14c, and 14d are attached to a front outer surface of the housing 108. With a front direction of the housing 108 taken for reference, the imaging apparatus 14a is attached to a top right corner of the front outer surface in a manner orienting a camera optical axis to the upper right. The imaging apparatus 14b is attached to a top left corner of the front outer surface in a manner orienting the camera optical axis to the upper left. The imaging apparatus 14c is attached to a bottom right corner of the front outer surface in a manner orienting the camera optical axis in the front direction. The imaging apparatus 14d is attached to the bottom left corner of the front outer surface in a manner orienting the camera optical axis in the front direction. The imaging apparatuses 14c and 14d constitute a stereo camera.

The HMD 100 transmits to the information processing apparatus 10 the images captured by the imaging apparatuses 14 and the sensor data acquired by the attitude sensor. The HMD 100 further receives game image data and game sound data generated by the information processing apparatus 10.

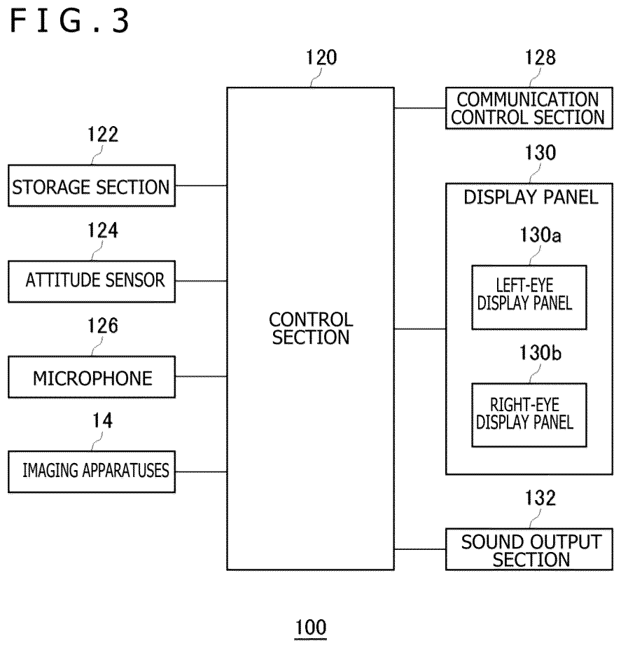

FIG. 3 indicates the functional blocks of the HMD 100. A control section 120 is a main processor that outputs various data such as image data, sound data, and sensor data, and processes instructions to output the result of the processing. A storage section 122 temporarily stores the data and instructions to be processed by the control section 120. An attitude sensor 124 acquires the sensor data regarding the movement of the HMD 100. The attitude sensor 124 may be an IMU (inertial measurement unit) including at least a three-axis acceleration sensor and a three-axis gyro sensor, detecting values on each of the axes (sensor data) in a predetermined cycle (e.g., 1,600 Hz).

A communication control section 128 transmits the data output from the control section 120 to an external information processing apparatus 10 by wire or wirelessly via a network adapter or an antenna. Also, the communication control section 128 receives data from the information processing apparatus 10 and outputs the received data to the control section 120.

Upon receipt of the game image data and game sound data from the information processing apparatus 10, the control section 120 supplies the received data to a display panel 130 for display and to a sound output section 132 for audio output. The display panel 130 is constituted by a left-eye display panel 130a and a right-eye display panel 130b, the panels displaying a pair of parallax images each. The control section 120 further causes the communication control section 128 to transmit to the information processing apparatus 10 the sensor data obtained by the attitude sensor 124, the sound data acquired by a microphone 126, and the captured images from the imaging apparatuses 14.

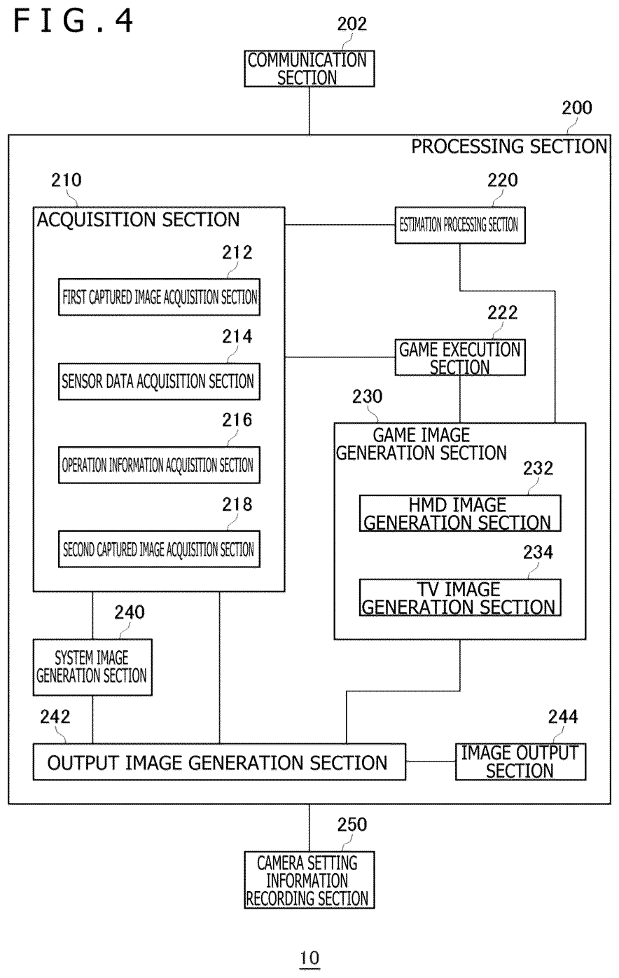

FIG. 4 indicates the functional blocks of the information processing apparatus 10. The information processing apparatus 10 includes a processing section 200 and a communication section 202. The processing section 200 includes an acquisition section 210, an estimation processing section 220, a game execution section 222, a game image generation section 230, a system image generation section 240, an output image generation section 242, and an image output section 244. The acquisition section 210 includes a first captured image acquisition section 212, a sensor data acquisition section 214, an operation information acquisition section 216, and a second captured image acquisition section 218. The game image generation section 230 includes an HMD image generation section 232 that generates the game image displayed on the HMD 100 and a TV image generation section 234 that generates the game image displayed on the output apparatus 15. A camera setting information recording section 250, configured as part of a recording region of the recording apparatus 11, records setting information regarding the camera image to be broadcast along with the game image.

The communication section 202 receives the operation information transmitted from the input device 16, and supplies the received information to the acquisition section 210. Also, the communication section 202 receives the captured images and sensor data transmitted from the HMD 100, and supplies what is received to the acquisition section 210. Further, the communication section 202 receives the captured image transmitted from the imaging apparatus 18 and supplies the received image to the acquisition section 210.

The information processing apparatus 10 includes a computer that executes programs to implement the various functions indicated in FIG. 4. In terms of hardware, the computer includes a memory into which to load programs, at least one processor that executes the loaded programs, an auxiliary storage apparatus, and other large scale integration (LSI). The processor is configured by multiple electronic circuits including semiconductor integrated circuits and LSIs. These electronic circuits may be mounted on a single or multiple chips. The functional blocks indicated in FIG. 4 are implemented through coordination between hardware and software. It will thus be understood by those skilled in the art that these functional blocks can be implemented by hardware alone, by software alone, or by a combination of both in diverse forms.

The first captured image acquisition section 212 acquires the images captured by the multiple imaging apparatuses 14, and supplies the acquired images to the estimation processing section 220. Based on the captured images, the estimation processing section 220 performs processes to estimate the position and attitude of the HMD 100 in order to derive position information and attitude information resulting from the estimation. The sensor data acquisition section 214 acquires the sensor data detected by the attitude sensor 124 of the HMD 100, and supplies the acquired sensor data to the estimation processing section 220. The estimation processing section 220 may preferably use the sensor data to improve the accuracy in estimating the position information and attitude information regarding the HMD 100.

Before starting to play games, the user wearing the HMD 100 performs initialization by capturing images of the surrounding environment using the imaging apparatuses 14 and registering the captured images. At the time of initialization, the information processing apparatus 10 defines the area in which the user plays games (i.e., the area in which the user can move) in order to ensure the safety of the user during game play. If the user appears likely to breach the play area during game play, the information processing apparatus 10 warns the user of an imminent breakout from the play area. During game play, the images of the surrounding environment registered at the time of initialization may be updated periodically by SLAM to create the latest environmental map.

The estimation processing section 220 acquires chronologically the images captured by the imaging apparatuses 14, and divides each of the images into a grid to detect a feature point. The estimation processing section 220 associates the feature points in the images captured at time (t-1) with the feature points in the images capture at time (t) to estimate the amount of movement of the feature point between the images captured at different times. Given the amount of movement of the feature points, the estimation processing section 220 estimates the amount of movement of the HMD 100 between time (t-1) and time (t). The estimation processing section 220 adds the amount of movement thus estimated to the position and attitude of the HMD 100 at time (t-1) to estimate the position information and attitude information regarding the HMD 100 at time (t). The estimated position information and attitude information regarding the HMD 100 are supplied to the game image generation section 230 or to the game execution section 222.

The operation information acquisition section 216 acquires the operation information transmitted from the input device 16 and supplies the acquired information to the game execution section 222. On the basis of the operation information from the input device 16, the game execution section 222 executes the game program and performs calculation processes for moving a player character operated by the user in the three-dimensional virtual reality space as well as NPCs (non-player characters).

The game image generation section 230 includes a GPU (Graphics Processing Unit) that executes processes such as rendering. Given the result of the calculation processing in the virtual reality space, the game image generation section 230 generates the game image as viewed from a virtual camera position in the virtual reality space. Incidentally, although not indicated, the information processing apparatus 10 includes a sound generation section that generates game sounds.

The HMD image generation section 232 generates the game image in the three-dimensional virtual reality space for display on the HMD 100 based on the position information and attitude information regarding the HMD 100. The HMD image generation section 232 may handle the position information and attitude information supplied from the estimation processing section 220 as the user's viewpoint position and line-of-sight direction, and convert the user's viewpoint position and line-of-sight direction into those of the player character operated by the user. At this time, the HMD image generation section 232 may let the user's line-of-sight direction coincide with that of the player character. The HMD image generation section 232 generates three-dimensional virtual reality (VR) images. Specifically, the HMD image generation section 232 generates a pair of parallax images including a left-eye game image and a right-eye game image.

The HMD 100 adopts optical lenses with a large curvature to display imagery with a wide viewing angle in front of and around the user's eyes. The HMD 100 is structured to let the user look into the display panel 130 through the lenses. Since imagery is distorted by distortion aberration of the lenses with large curvature, the HMD image generation section 232 corrects the rendered images for distortion to let the images be seen correctly through the lenses. That is, the HMD image generation section 232 generates left-eye and right-eye images corrected for optical distortion caused by the lenses.

On the other hand, the TV image generation section 234 generates a two-dimensional image displayed on a flat-screen display such as a television receiver. In the embodiment, the TV image generation section 234 in mirroring mode generates the two-dimensional image (game image from the same virtual camera) with substantially the same viewing angle as the display image on the HMD 100. Incidentally, in a modification, the TV image generation section 234 may generate a two-dimensional game image captured by a virtual camera different from the virtual camera generating the image for the HMD 100.

The system image generation section 240 generates a system image overlaid on the game image, or a system image displayed in place of the game image. When the operation information acquisition section 216 acquires the operation information from the user for displaying the system image during the user's game play, the system image generation section 240 generates the system image overlaid on the game image.

The output image generation section 242 receives the game image generated by the game image generation section 230 and the system image generated by the system image generation section 240 to generate the image to be output the HMD 100 and to the output apparatus 15. During game play, the system image generation section 240 generates no system image if the user does not operate the input device 16 to have the system image displayed. At this time, the output image generation section 242 assumes the game image generated by the HMD image generation section 232 (the image may be referred to as an “HMD game image” hereunder) to be the image output to the HMD 100 and the game image generated by the TV image generation section 234 (the image may be referred to as a “TV game image” hereunder) to be the image output to the output apparatus 15. The image output section 244 outputs the HMD game image (a pair of parallax images) to the HMD 100 and the TV game image to the output apparatus 15 by way of the communication section 202.

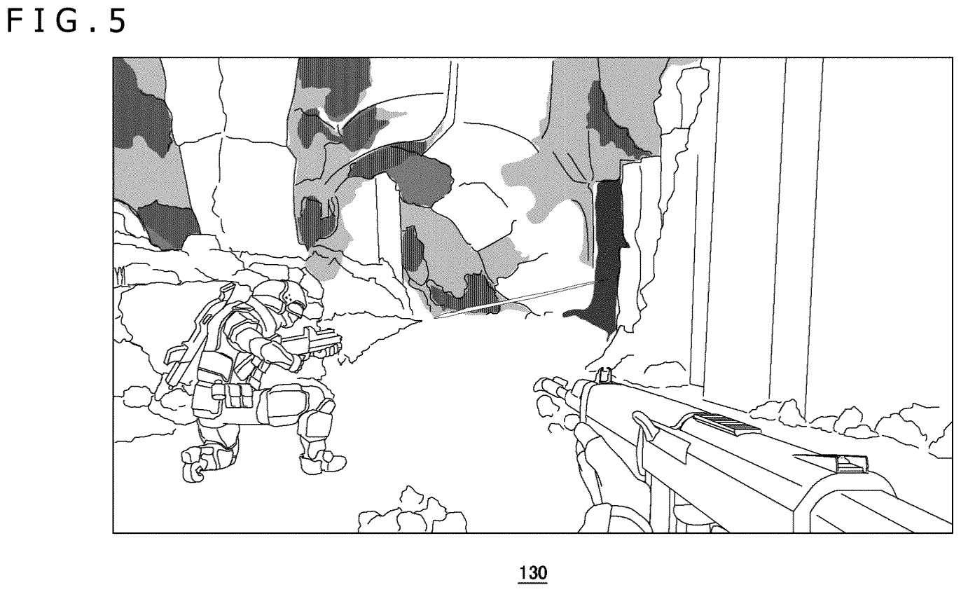

FIG. 5 depicts an exemplary game image displayed on the display panel 130. In the HMD 100, the control section 120 displays a pair of parallax images on the display panel 130. As mentioned above, the display panel 130 includes the left-eye display panel 130a and the right-eye display panel 130b. The control section 120 displays the left-eye game image and the right-eye game image on the left-eye display panel 130a and on the right-eye display panel 130b, respectively. In the embodiment, the game image with its viewing angle indicated in FIG. 5 is also displayed on the output apparatus 15.

When the user presses a predetermined button (i.e., a create button) of the input device 16 during game play, the operation information acquisition section 216 acquires the operation information for displaying a first system image, and the system image generation section 240 generates the first system image including items for game image broadcast. The output image generation section 242 overlays the first system image on both the HMD game image and the TV game image.

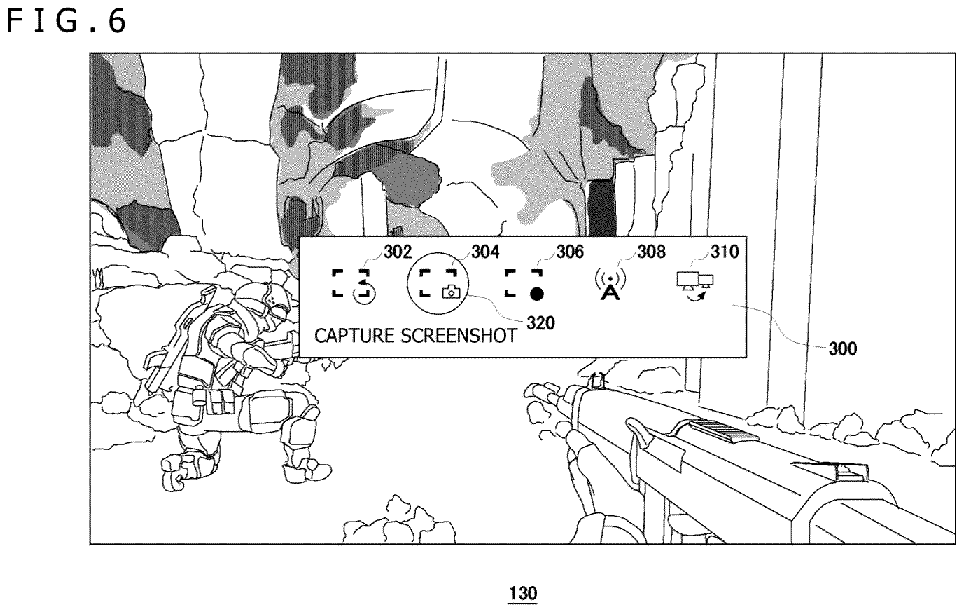

FIG. 6 depicts an exemplary first system image 300 displayed on the display panel 130. The first system image 300 includes multiple menu items regarding the capture and sharing of images. What follows is an explanation of each of the menu items.

### Menu Item 302

This menu item is for “saving the latest game play.” In default, the latest game play of up to 60 minutes is saved. By setting a save period of time, the user may save the latest game play of up to 15 seconds or 30 seconds, for example.

### Menu Item 304

This menu item is for “capturing a screen shot.”

### Menu Item 306

This menu item is for “starting new recording.” During video recording, a red circular mark and an indication of an elapsed period of time from the start of recording are displayed in an upper part of the screen.

### Menu Item 308

This menu item is for starting “broadcast.” This is a menu item for game image broadcast. When the menu item 308 is selected and a decision operation is performed, a second system image for game image broadcast is displayed.

### Menu Item 310

This menu item is for starting “share-screen.” When selected, this item allows the user to share game play with party members.

The user selects a desired menu item by moving a selection frame 320 onto the position of that menu item. In the example in FIG. 6, the selection frame 320 is placed on the menu item 304 to select the menu item “capture screenshot.”

The output image generation section 242 overlays the first system image 300 on a predetermined region of the HMD game image. In this example, the output image generation section 242 overlays the first system image 300 on a region approximately at the center of the HMD game image. When the user moves the head, the HMD image generation section 232 generates the HMD game image based on the user's changed viewpoint position and line-of-sight direction, whereas the output image generation section 242 always places the first system image 300 in the region approximately at the center of the HMD game image. With the first system image 300 always displayed in the approximately central region of the display panel 130, the user can easily select the desired menu item included in the first system image 300 without losing sight of the first system image 300.

Likewise, the output image generation section 242 overlays the first system image 300 on a predetermined region of the TV game image. The output image generation section 242 may overlay the first system image 300 on a region approximately at the center of the TV game image. This allows other users viewing the output apparatus 15 to easily recognize that the user wearing the HMD 100 is selecting the menu options.

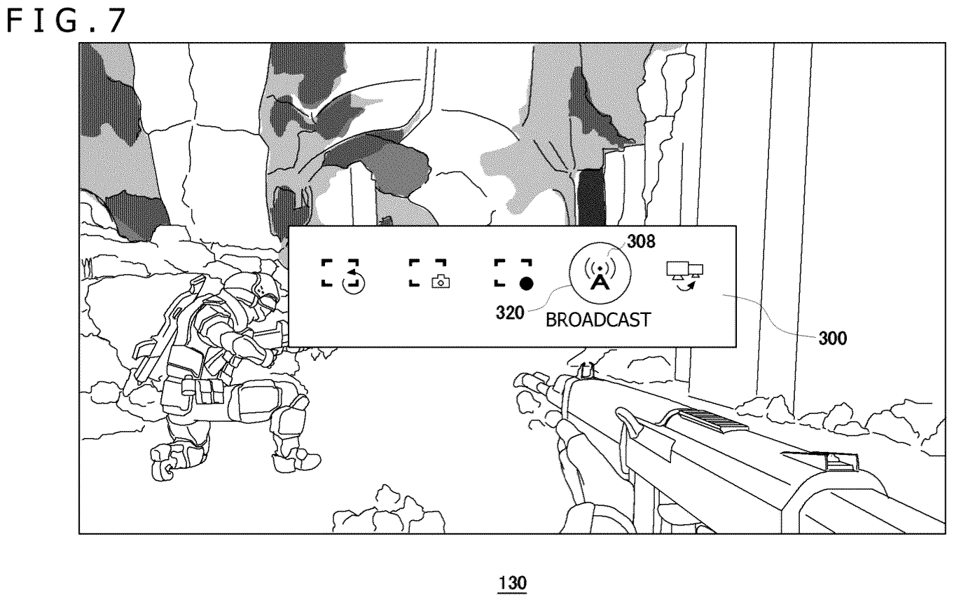

FIG. 7 depicts an exemplary first system image 300 displayed on the display panel 130. In this example, the selection frame 320 is placed on the menu item 308 to select the menu item for starting “broadcast.” When the user presses an OK button of the input device 16, the operation information acquisition section 216 acquires the operation information for selecting the menu item 308. The operation information for selecting the menu item 308 is the operation information for broadcasting the game image. When the menu item 308 is selected, the system image generation section 240 generates a second system image for game image broadcast. Note that the embodiment is configured such that the user presses a predetermined button (i.e., the create button) to have the first system image 300 displayed and selects the menu item 308 in the first system image 300 to start broadcast. Alternatively, the user may press a home button of the input device 16 to start broadcast from a control center.

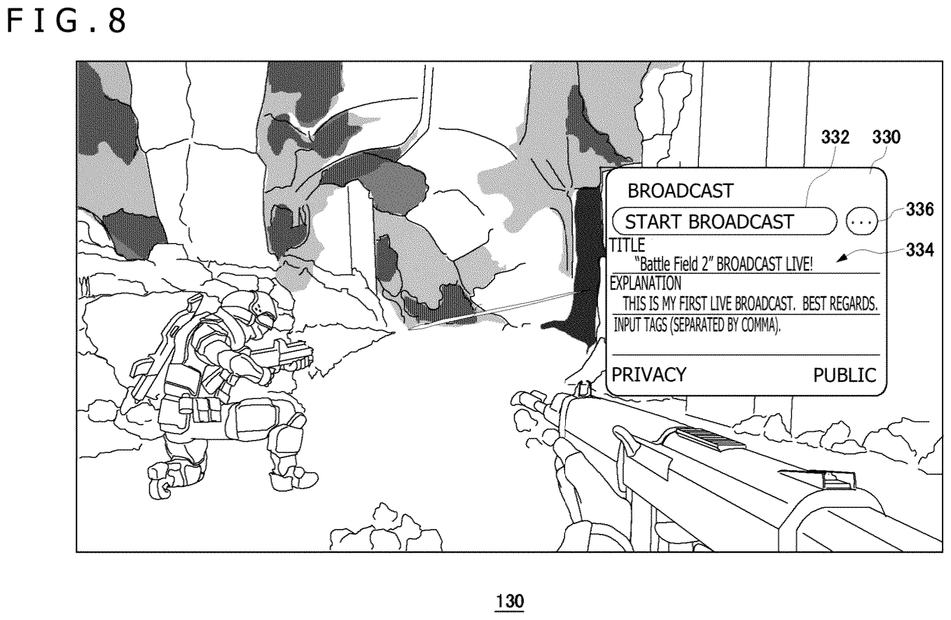

FIG. 8 depicts an exemplary second system image 330 displayed on the display panel 130. When the operation information acquisition section 216 acquires the operation information for selecting the item for game image broadcast (i.e., the menu item 308) included in the first system image 300, the system image generation section 240 generate the second system image 330 for game image broadcast. The game image generation section 230 places the second system image 330 in a predetermined position in the three-dimensional virtual reality space. The game image generation section 230 may place the second system image 330 in an appropriate initial position and fix the second system image 330 in that position. The game image generation section 230 may position the second system image 330 wherever desired in the virtual reality space as long as the second system image 330 is included in the display panel 130 at the time when operations are performed to determine the menu item 308. The game image generation section 230 may determine an appropriate position where to place the second system image 330 within the viewing angle in the three-dimensional virtual reality space and fix the second system image 330 in that determined position.

With the second system image 330 fixed in the appropriate position in the three-dimensional virtual reality space, the user may move the head to put the second system image 330 out of the viewing angle (i.e., the second system image 330 is not displayed on the display panel 130). When the second system image 330 is prevented from following the user's line-of-sight direction, it is possible to avoid a situation where game progress is hampered by the second system image 330 continuously hiding part of the HMD game image.

In the second system image 330, the user inputs explanatory notes regarding broadcast to an input region 334. The explanatory notes input in the input region 334 may be viewed by users viewing the broadcast image.

When the user operates a button 336, the operation information acquisition section 216 acquires the operation information indicative of the operation of the button 336. The system image generation section 240 then generates a menu list that includes a broadcast option among other options. When the user selects the broadcast option from the menu list, the operation information acquisition section 216 acquires the operation information indicative of the selection of the broadcast option. The system image generation section 240 then generates a third system image for setting broadcast-related options.

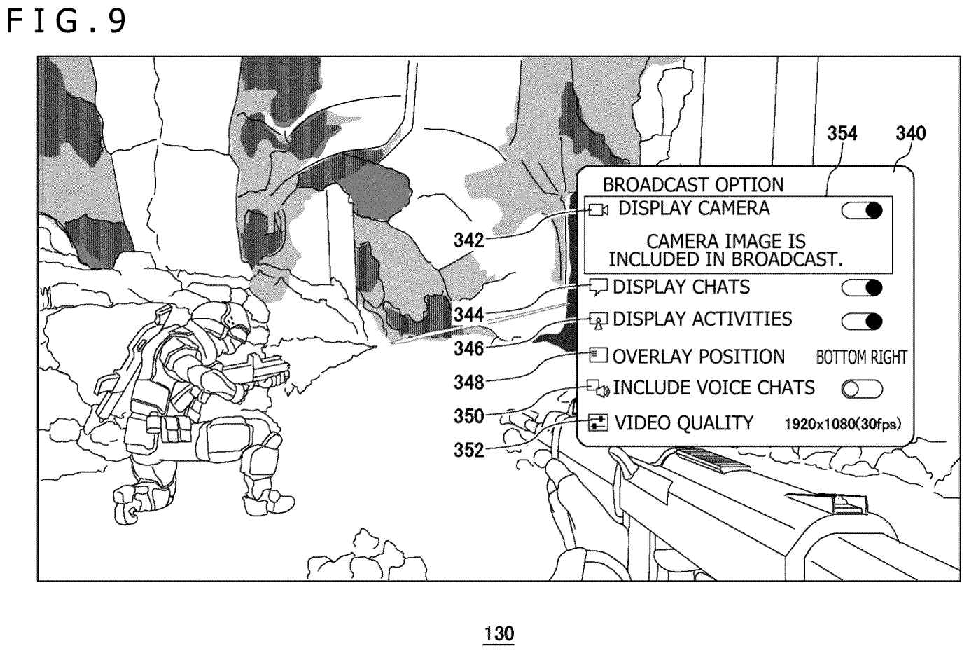

FIG. 9 depicts an exemplary third system image 340 displayed on the display panel 130. The game image generation section 230 places the third system image 340 in a predetermined position in the three-dimensional virtual reality space and fixes the third system image 340 in that position. This allows the user to put the third system image 340 out of sight by moving the line-of-sight direction. The third system image 340 includes multiple broadcast-related menu items. What follows is an explanation of each of these menu items.

### Menu Item 342

This menu item is for setting whether or not to include the camera image captured by the imaging apparatus 18 in the broadcast game image.

### Menu Item 344

This menu item is for setting whether or not to display chats.

### Menu Item 346

This menu item is for setting whether or not to display, on the user's screen, notices from growing numbers of viewers and channel followers.

### Menu Item 348

This menu item is for setting the position where chats or activities are displayed.

### Menu Item 350

This menu item is for setting whether or not to include the voice of voice chat members in the broadcast.

### Menu Item 352

This menu item is for setting the resolution of broadcasting game play.

The user moves a selection frame 354 onto the position of a desired menu item to select the menu item, and inputs setting details. In the example in FIG. 9, the selection frame 354 is placed on the menu item 342 to set that the imaging apparatus 18 is to broadcast the camera image captured thereby. In the embodiment, the information processing apparatus 10 allows the user wearing the HMD 100 to set whether or not to include the camera image in the broadcast.

As described above, during game play, the user may have the third system image 340 displayed and set whether or not to include the camera image captured by the imaging apparatus 18 in the broadcast game image. Incidentally, before starting game play, the user may be allowed to set whether or not to include the camera image captured by the imaging apparatus 18 in the broadcast game image.

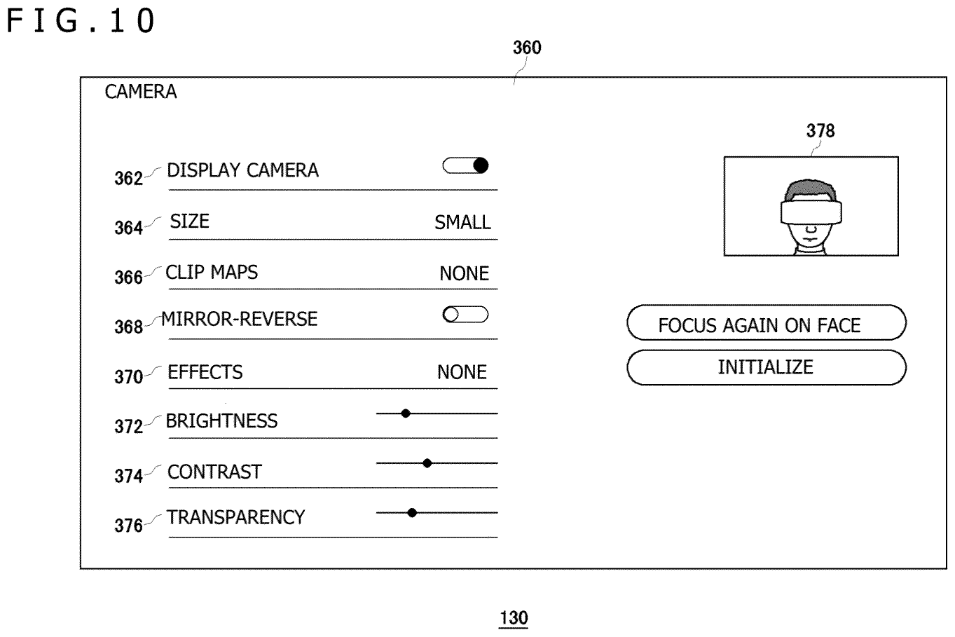

FIG. 10 depicts an exemplary fourth system image 360 displayed on the display panel 130. Before starting game play, the user may have the fourth system image 360 displayed on the display panel 130 to make settings regarding the camera image to be broadcast along with the game image. The user can set the menu items in the fourth system image 360 while wearing the HMD 100. Also, during game play or during image broadcast, the user may have the fourth system image 360 displayed on the display panel 130 to make settings regarding the camera image. What follows is an explanation of each of the menu items involved.

### Menu Item 362

This menu item is for setting whether or not to include the camera image captured by the imaging apparatus 18 in the broadcast game image.

### Menu Item 364

This menu item is for setting the size of the broadcast camera image.

### Menu Item 366

This menu item is for setting the shape of the broadcast camera image.

### Menu Item 368

This menu item is for setting whether or not to mirror-reverse the broadcast camera image.

### Menu Item 370

This menu item is for setting the effects to be made on the broadcast camera image.

### Menu Item 372

This menu item is for setting the brightness of the broadcast camera image.

### Menu Item 374

This menu item is for setting the contrast of the broadcast camera image.

### Menu Item 376

This menu item is for setting the transparency of the broadcast camera image.

The second captured image acquisition section 218 acquires the camera image captured by the imaging apparatus 18. The captured camera image is displayed in a display region 378. The user may adjust the mounting position of the imaging apparatus 18 by viewing the display region 378. With the details of the menu items set by the user, the camera setting information recording section 250 records the details of the set menu items.

The camera setting information thus recorded is used at the time of camera image broadcast.

Returning to FIG. 8, when the user operates a start broadcast button 332, the operation information acquisition section 216 acquires the operation information indicative of the operation of the start broadcast button 332. The image output section 244 then activates a broadcast function and starts a process of connecting with the server apparatus as the broadcast destination.

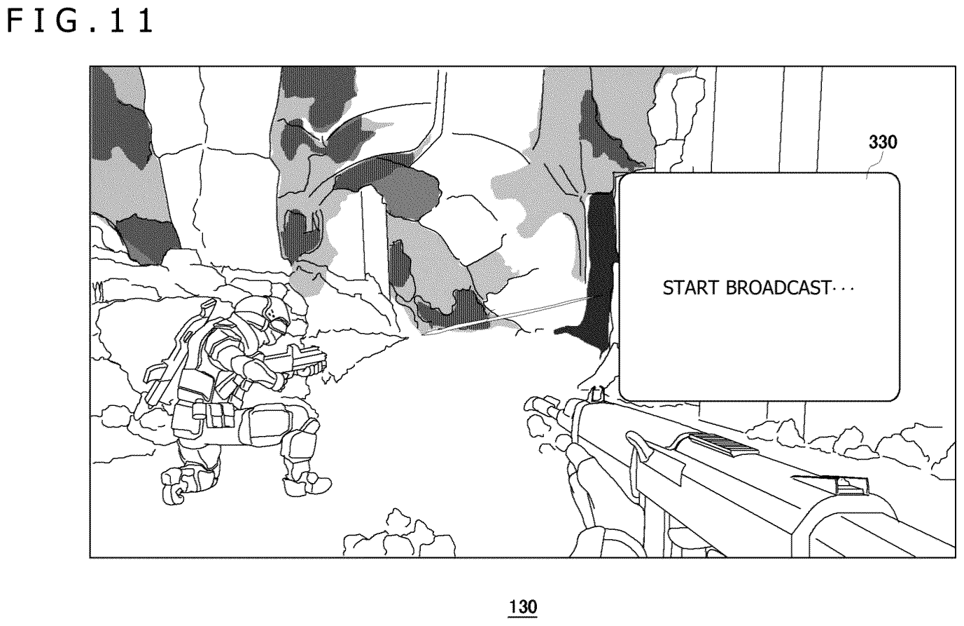

FIG. 11 depicts an exemplary second system image 330 at the time the broadcast function of the image output section 244 is activated. With the broadcast function activated, the system image generation section 240 generates a system image in which the user selects that position in the broadcast game image on which the camera image is overlaid.

### Determining Overlay Position of Camera Image

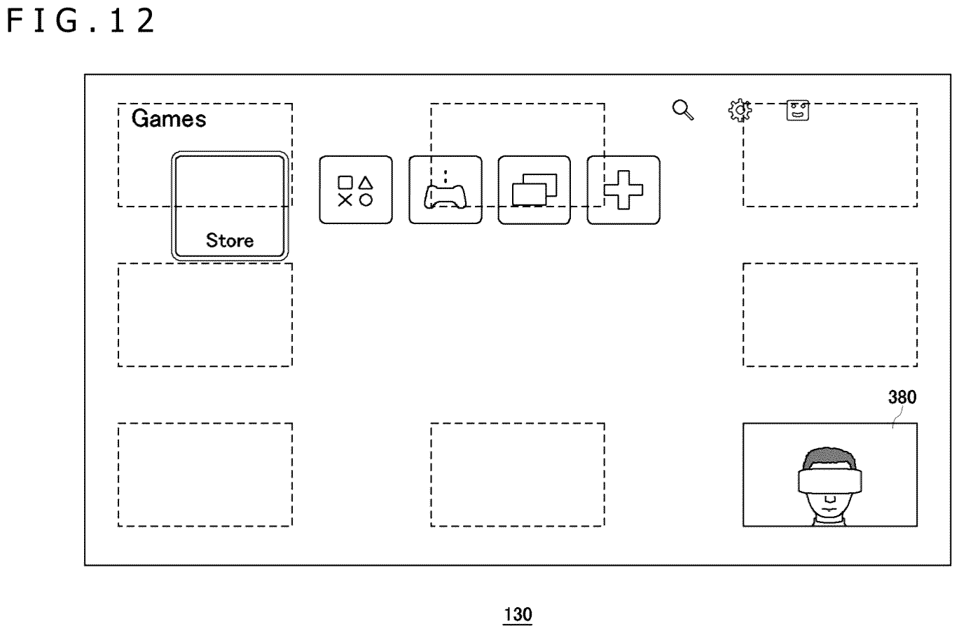

FIG. 12 depicts an exemplary fifth system image 380 displayed on the display panel 130. The system image generation section 240 generates the fifth system image 380 that allows the user to select that position in the broadcast game image on which the camera image is overlaid. The user may move the fifth system image 380 by operating the arrow keys of the input device 16. The output image generation section 242 moves the fifth system image 380 based on arrow key operation information acquired by the operation information acquisition section 216. The user may alternatively operate the analog sticks of the input device 16 to move the fifth system image 380. The embodiment allows one of eight positions indicated by broken lines in FIG. 12 to be selected as the overlay position of the camera image. The user thus moves the fifth system image 380 to the desired overlay position.

In FIG. 12, a home image is displayed in the background of the fifth system image 380. At the time of displaying the fifth system image 380, the output image generation section 242 in the embodiment switches the game image displayed in the background to the home image. The system image generation section 240 thus generates the home image and supplies it to the output image generation section 242. In turn, the output image generation section 242 displays the fifth system image 380 against the background of the home image. Alternatively, the output image generation section 242 may display the fifth system image 380 with the game image kept in the background.

The fifth system image 380 includes the camera image captured by the imaging apparatus 18. This enables the user to verify the actually broadcast camera image. If an object not desired to be broadcast is found in the camera image, for example, the user can take an appropriate action such as removing the object in question.

Incidentally, in the embodiment, the output apparatus 15 displays the same display image as that on the display panel 130. Accordingly, the same image as that in FIG. 12 on the output apparatus 15, other users recognize the situation in which the user wearing the HMD 100 is selecting the overlay position of the camera image.

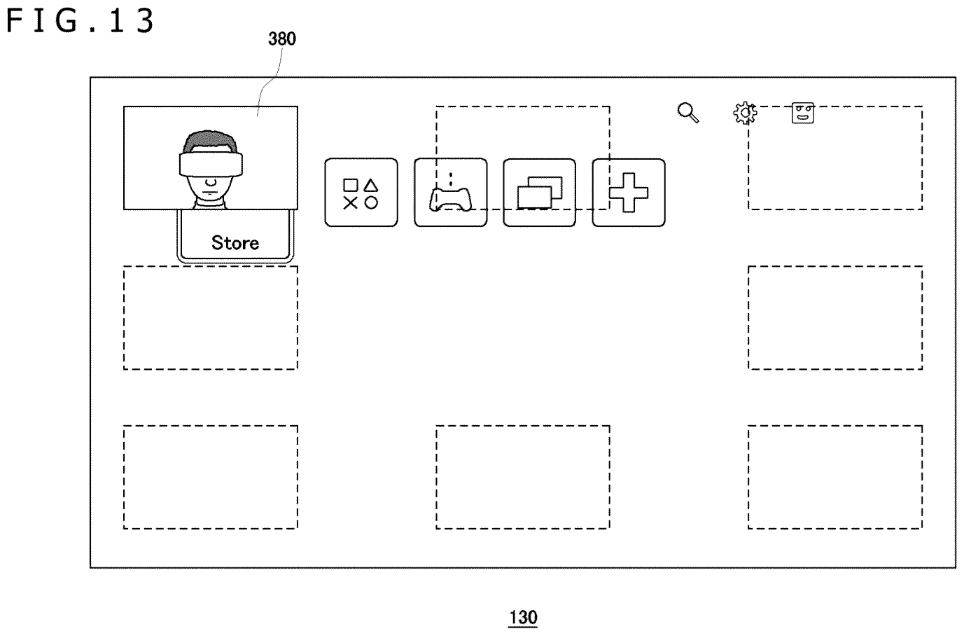

FIG. 13 depicts a state in which the fifth system image 380 is placed in the top left corner of the screen. The user determines the position of the camera image suitable for broadcast by moving the fifth system image 380. When the user presses the OK button of the input device 16, the operation information acquisition section 216 acquires the operation information for determining the overlay position of the camera image. When the overlay position of the camera image is determined in the top left corner of the screen, the output image generation section 242 switches the image for display on the HMD 100 to the HMD game image and the image for display on the output apparatus 15 to the TV game image.

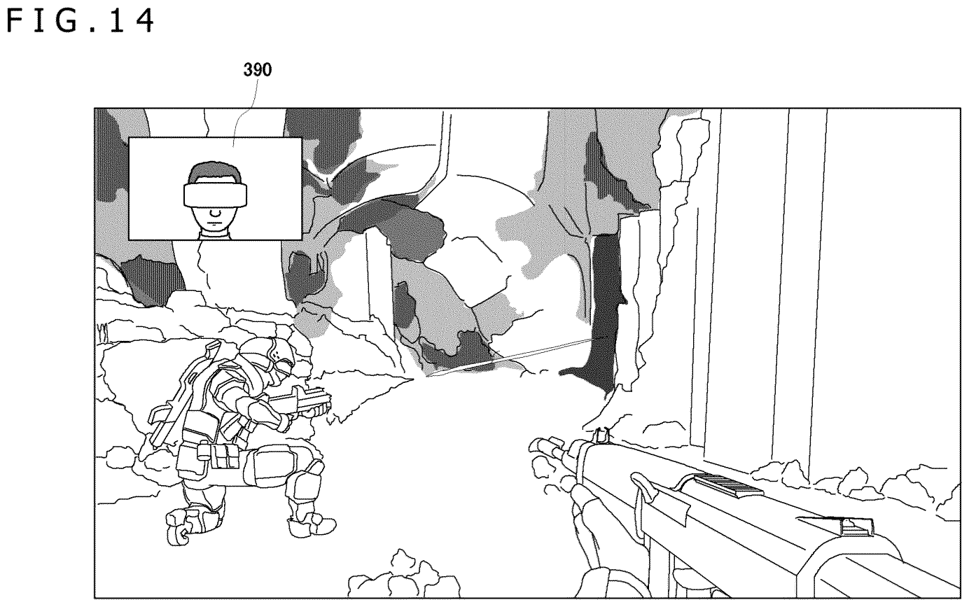

FIG. 14 depicts an image displayed on the output apparatus 15. After the overlay position of the camera image is determined, the output image generation section 242 generates the TV game image in which the camera image is overlaid on the determined position, and supplies the generated image to the image output section 244. The output image generation section 242 modifies the camera image in accordance with the camera setting information recorded in the camera setting information recording section 250, and places the modified camera image in the top left corner of the TV game image. The image output section 244 outputs the TV game image overlaid with a camera image 390 to the output apparatus 15.

In the embodiment, the image output section 244 outputs the TV game image overlaid with the camera image 390 to the server apparatus that provides a video delivery service. That is, the embodiment streams the TV game image displayed on the output apparatus 15. Whereas the HMD game image is corrected for optical distortion, the TV game image is not subjected to such correction. That means high-quality streaming is implemented when the TV game image is targeted for broadcast.

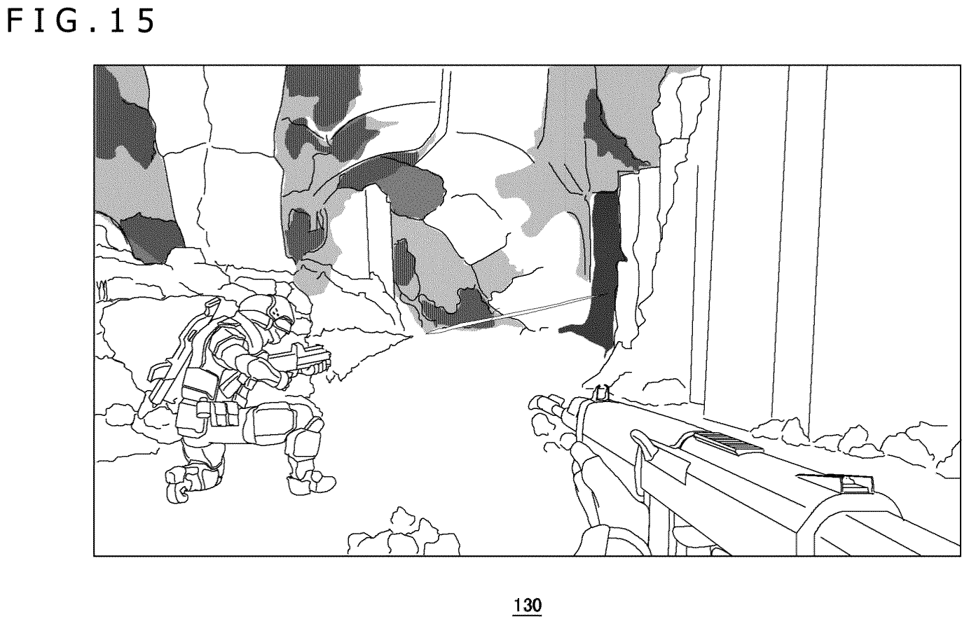

FIG. 15 depicts an image displayed on the display panel 130. After the overlay position of the camera image is determined, the output image generation section 242 supplies the HMD game image not overlaid with the camera image to the image output section 244. The image output section 244 outputs the HMD game image not overlaid with the camera image to the HMD 100. As a result, the camera image is not displayed overlaid on the game image viewed by the user wearing the HMD 100. With the camera image not displayed overlaid on the HMD game image, the user can play games without being bothered by the camera image.

In the embodiment, the HMD image generation section 232 generates the game image in the three-dimensional virtual reality space for display on the HMD 100 on the basis of the position information and attitude information regarding the HMD 100 estimated by the tracking process. From the position information and attitude information supplied from the estimation processing section 220, the HMD image generation section 232 derives the viewpoint position and line-of-sight direction of the play character in order to set the position and direction of the virtual camera accordingly. In a modification, the HMD image generation section 232 may set the direction of the virtual camera using the attitude information without recourse to the position information regarding the HMD 100 in generating the HMD game image in the three-dimensional virtual reality space.

Note that the HMD image generation section 232 may have a function of generating not the three-dimensional VR game image but two-dimensional videos (e.g., two-dimensional videos such as two-dimensional game images and movies). When generating the two-dimensional video, the HMD image generation section 232 complies with the operation information from the input device 16 without recourse to the position information and/or the attitude information regarding the HMD 100. It has been explained that the embodiment allows the user wearing the HMD 100 on the head to make the settings of the camera image broadcast along with the game image. Preferably, the user may perform the settings regarding the camera image when the HMD image generation section 232 generates the three-dimensional VR game image. Incidentally, when the HMD image generation section 232 generates two-dimensional videos, the user need not perform the settings regarding the camera image.

The present disclosure has been described in conjunction with a specific embodiment given as an example. It should be understood by those skilled in the art that the above-described constituent elements and various processes may be combined in diverse ways and that such combinations, variations, and modifications also fall within the scope of this disclosure. Whereas the above embodiment has been explained in terms of the processing for game image broadcast, this disclosure may also be applied to processes for broadcasting content images other than the game image.

In the embodiment, the image output section 244 streams the TV game image overlaid with the camera image 390. Alternatively, the HMD game image overlaid with the camera image 390 may be streamed. As another alternative, the image output section 244 may selectively stream either the TV game image overlaid with the camera image 390 or the HMD game image overlaid therewith. As a further alternative, the image output section 244 may stream both the TV game image overlaid with the camera image 390 and the HMD game image overlaid therewith. As an even further alternative, the image output section 244 may be arranged to stream a composite image overlaid with the camera image 390 and combined with the TV game image and HMD game image. In this case, the camera image 390 may be overlaid either on the TV game image or on the HMD game image, or on both.

### Industrial Applicability

The present disclosure can be applied advantageously to technical fields in which images for display on the head-mounted display are generated.

### Reference Signs List

1: Information processing system
10: Information processing apparatus
15: Output apparatus
16: Input device
18: Imaging apparatus
100: HMD
130: Display panel
130a: Left-eye display panel
130b: Right-eye display panel
200: Processing section
202: Communication section
210: Acquisition section
212: First captured image acquisition section
214: Sensor data acquisition section
216: Operation information acquisition section
218: Second captured image acquisition section
220: Estimation processing section
222: Game execution section
230: Game image generation section
232: HMD image generation section
234: TV image generation section
240: System image generation section
242: Output image generation section
244: Image output section
250: Camera setting information recording section

1. An information processing apparatus comprising:
at least one processor having hardware, wherein
the at least one processor performs
deriving attitude information indicative of an attitude of a head-mounted display worn by a user on the head,
generating a content image in a three-dimensional virtual reality space for display on the head-mounted display on a basis of the attitude information regarding the head-mounted display, and
generating a system image allowing the user wearing the head-mounted display on the head to make settings regarding a camera image for broadcast along with the content image.

2. The information processing apparatus according to claim 1, wherein the at least one processor further performs
acquiring, from the user, operation information for broadcasting the content image while the head-mounted display is displaying the content image, and
generating the system image for making the settings regarding the camera image after the operation information for broadcasting the content image is acquired.

3. The information processing apparatus according to claim 2, wherein the at least one processor further performs
generating a first system image including an item for broadcasting the content image when the operation information for displaying the first system image is acquired, and
generating a second system image for broadcasting the content image when the operation information for selecting the item for broadcasting the content image is acquired.

4. The information processing apparatus according to claim 3, wherein
the first system image is overlaid on a predetermined region of the content image displayed on the head-mounted display, and
the second system image is placed in a predetermined position in the three-dimensional virtual reality space.

5. The information processing apparatus according to claim 1, wherein the at least one processor further generates a system image allowing the user to select the position on which to overlay the camera image in the broadcast content image.

6. The information processing apparatus according to claim 5, wherein the at least one processor further generates a system image that includes the camera image.

7. The information processing apparatus according to claim 1, wherein the at least one processor generates a first content image for display on the head-mounted display and a second content image for display on a flat-screen display, and the broadcast camera image is displayed overlaid on the second content image but not displayed overlaid on the first content image.

8. The information processing apparatus according to claim 7, wherein the at least one processor broadcasts the second content image overlaid with the camera image.

9. An image generation method comprising:
deriving attitude information indicative of an attitude of a head-mounted display worn by a user on the head;
generating a content image in a three-dimensional virtual reality space for display on the head-mounted display on a basis of the attitude information regarding the head-mounted display; and
generating a system image allowing the user wearing the head-mounted display on the head to make settings regarding a camera image for broadcast along with the content image.

10. A program for causing a computer to realize, comprising:
by at least one processor, deriving attitude information indicative of an attitude of a head-mounted display worn by a user on the head;
by the at least one processor, generating a content image in a three-dimensional virtual reality space for display on the head-mounted display on a basis of the attitude information regarding the head-mounted display; and
by the at least one processor, generating a system image allowing the user wearing the head-mounted display on the head to make settings regarding a camera image for broadcast along with the content image.
